(19) United States
(12) Patent Application Publication
(10) Pub. No.: US 2005/0150113 A1
(43) Pub. Date: Jul. 14, 2005

(54) Tube cutting device

(76) Inventor: Emil Shultis, Leed, NY (US)

Correspondence Address: JOHN MAIER, III, 660 AARON COURT, KINGSTON, NY, 12401, US

(21) Appl. No.: 11/032,784

(22) Filed: Jan. 11, 2005

Related U.S. Application Data
(60) Provisional application No. 60/535,372, filed on Jan. 12, 2004.

(51) Int. Cl. B23D 21/06

(52) U.S. Cl. 30/101; 30/102

(57) ABSTRACT

A Tube Cutting Device is provided with a casing having a circular shape and an open interior for access to the open interior. A ring is mounted within the casing to rotate in the casing to rotate in the casing. The ring has a main section and a hinged section that opens. A cutting wheel is mounted on the ring. The casing is mounted on a shaft enclosure extending from an electric motor with a shaft of the motor which rotates within the shaft enclosure. The ring has gear teeth about its periphery and a gear on the shaft energizes the gear teeth on the ring to rotate the ring within the casing. The cutting wheel thus rotates about a tube or pipe placed inside the ring. A switch on the motor permits energizing and de-energizing the motor and a handle is held connected to the motor to hold the Tube Cutting Device. A power source is connected to the switch and may be a power pack or electrical cord. Spaces are used within the ring of varying sizes for tube or pipe cutting of varying lengths.

### CROSS REFERENCE TO A RELATED APPLICATION

This application claims the benefit of an earlier filing date under 35 USC 119(e) of Provisional Patent Application No. 60/535,372, which was filed in the U.S. Patent and Trademark Office on Jan. 12, 2004 and entitled TUBING CUTTER.

### BACKGROUND OF THE INVENTION

1. Field of the Invention

The invention relates to cutting devices and more specifically to a tube cutting device that can be used in a restricted space.

2. Prior Art

Cutters for use on tubing are known in the art. Commonly used tubing cutters are either hand operated or are power driven. Hand operated cutters are awkward and, worst of all, frequently cannot be used in a tight space that so frequently occurs, in a plumbing job. Power operated cutters for tubing are available but the inclusion of a power source often results in a device that is more cumbersome than even a hand cutter.

### OBJECTS

The objects of the invention are to provide a Tube Cutting Device as follows:

That can be used in a close space.

That is easy to use.

That rapidly cuts a tube.

That can be readily placed about a tube.

That is economical and dependable.

### SUMMARY OF THE INVENTION

A Tube Cutting Device is provided with a casing having a circular shape and an open interior and an open interior and an open section for access to the open interior. A ring is mounted within the casing to rotate in the casing. The ring has a main section and a hinged section that opens. A cutting wheel is mounted on the ring, and means are provided to rotate the ring within the casing.

### BRIEF DESCRIPTION OF THE DRAWINGS

To provide a Tube Cutting Device that is economical and dependable.

FIG. 1 is a perspective view of the Tube Cutting Device with the hinged section closed.

FIG. 2 is a side view similar to FIG. 1 showing the Tube Cutting Device with the jaw of the cutting head closed.

FIG. 2A is an enlarged view of the cutting head shown in FIG. 2 partially broken away showing the shaft and drive gear engaging a portion of the rim gear.

FIG. 3 is a side view of the cutting head of the Tube Cutting Device turned upside down from FIGS. 1 and 2 with the hinged portion open and showing the spacer removed FIG. 4 is a side view similar to FIG. 3 with the spacer in the cutting and a tube located outside the Tube Cutting Device showing the manner of placement of a tube into the cutting head.

FIG. 5 is a perspective view of the inside of the cutting head with the hinged section removed showing the magnet for holding the spacer.

FIG. 5A is a perspective view of the spacer. FIG. 6 is a perspective view of the cutting head directed at the side of the cutting head with the hinged section open showing the hinge with the spacer removed.

DESCRIPTION OF THE NUMERALS

| NUMERAL | DESCRIPTION |
|---|---|
| 11 | CUTTING HEAD |
| 13 | MOTOR |
| 15 | HANDLE |
| 17 | BATTERY PACK |
| 19 | SWITCH |
| 21 | OUTSIDE END |
| 23 | SHAFT |
| 25 | SHAFT ENCLOSURE |
| 27 | CASING |
| 29 | U-SHAPED CHANNEL |
| 31 | OPEN SECTION |
| 33 | RING |
| 35 | OPEN CENTER |
| 37 | MAIN SECTION |
| 39 | HINGED SECTION |
| 41 | HINGED |
| 43 | SIDES |
| 45 | GEAR TEETH |
| 47 | GEAR |
| 49 | CUTTING WHEEL |
| 51 | AXLE |
| 53 | INDENTATION |
| 55 | CUTTING WHEEL SUPPORT |
| 57 | CENTER AREA |
| 59 | STOP BAR |
| 61 | FEMALE RETAINING UNIT |
| 62 | MALE RETAINING UNIT |
| 63 | SPACER |
| 64 | U-SHAPED CROSS SECTION |
| 65 | OUTSIDE SURFACE |
| 66 | TUBE OR PIPE |
| 67 | ROLLER |
| 71 | MAGNET |

### DETAILED DESCRIPTION OF THE PREFERRED EMBODIMENT

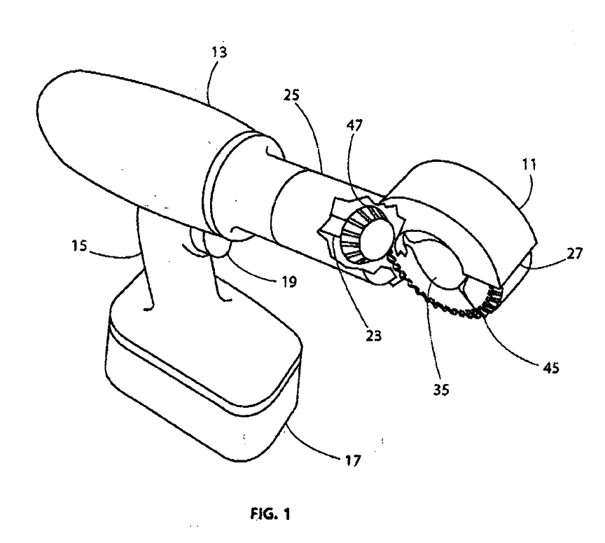

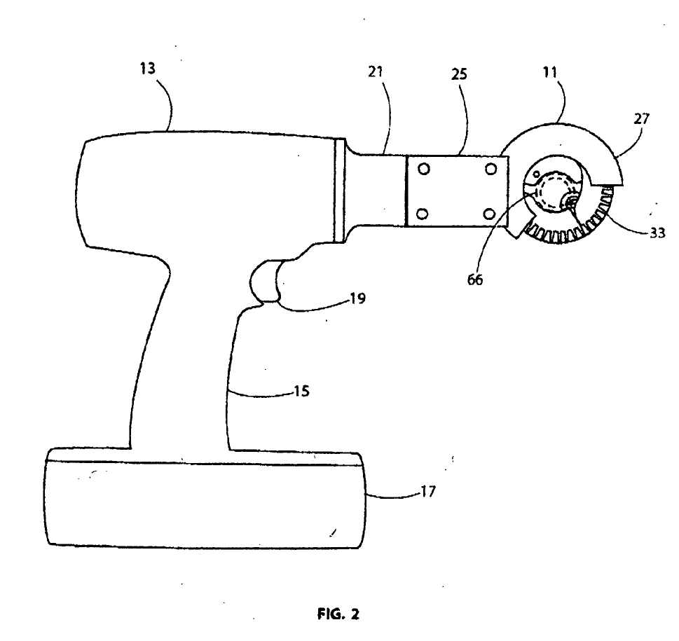

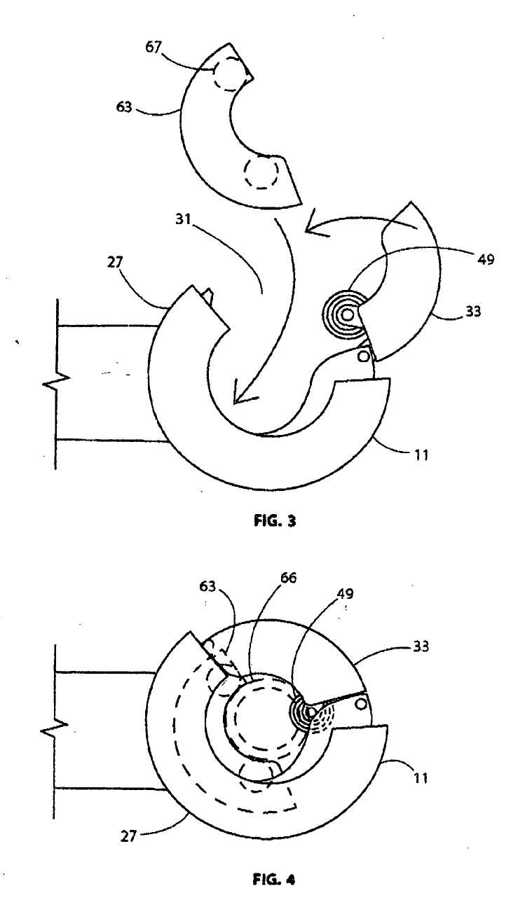

In FIG. 1 and FIG. 2, The Tube Cutting Device is shown with the cutting head 11 closed. The Tube Cutting Device has a motor 13 mounted on a handle 15 with a battery pack 17 at the end of the handle 15 opposite from the motor 13. A switch 19 is located on the handle 15 to engage and disengage the motor from the power pack 17. This configuration is generally the same as a battery powered drill-screw driver. The Tube Cutting Device can also be powered through an electrical cord connected to an outlet. thereby, eliminating the battery pack 17. The cutting head 11 is mounted at the outside end 21 of the motor 13.

The motor 13 has a shaft 23 (FIG. 2A ) which rotates with the motor 13 enclosed within a shaft enclosure 25 which extends from the motor 13. The shaft 23 rotates within the shaft enclosure 25 and is connected to the motor 13 and therefore rotates with the motor 13.

The cutting head 11 which has a general circular configuration is constructed within a casing 27 secured to the shaft enclosure 25. The casing 27 has a U-shaped channel 29 within its interior. The casing 27 extends more than halfway about the cutting head 11 but not entirely around the cutting head 11. The casing 27, as a result, has an open section 31.

Mounted within the U-shaped channel 29 of the casing 27 is a ring 33. The ring 33, which is generally circular, with an open center 35, has a generally rectangular cross section adapted to fit within the U-shaped channel 29 and to slide within the U-shaped channel 29. The ring 33, although it forms a complete circle, includes a main section 37 and has a hinged 39 section (FIG. 6). The hinged section 39 is connected to the main section 37 by a hinge 41 which permits the hinged section 39 to fold out of the ring 33 thereby providing access to the open center 35 of the ring 33. It is essential that access be provided to the open center 35 of the ring 33 within the casing 27. However, to do so, the hinged section 39 must be aligned with the open section 31 of the casing 27 and be just slightly smaller than the open section 51.

As best seen in FIG. 1, the ring 33, which has two sides 43 has gear teeth 45 on one side about the periphery of the ring 33. The shaft 23 has a gear 47 most usually a bevel gear, mounted on the end of the shaft 23 remote from the motor 13 which engages the gear teeth 45 on the ring 33. Therefore, as the motor 13 and shaft 23 turns, the gear 47 rotates the ring 33 within the casing 27.

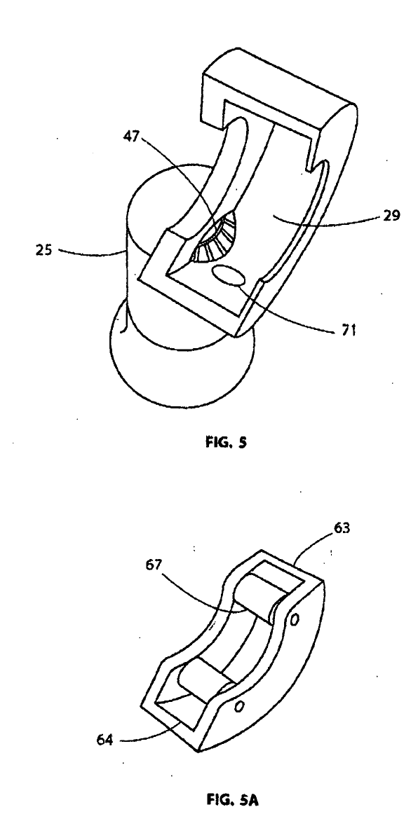

As seen in FIGS. 3, 4 and 6, a cutting wheel 49 is mounted in the hinged section 39 of the ring 33. The cutting wheel 49 is aligned with both the ring 33 and the casing 27 and the cutting wheel 49 rotates on an axle 51 located at right angles to the sides 43 of the ring 33. The cutting wheel 49 rotates about its axle 51 as the cutting wheel 49 rotates with the ring 33.

Adjacent the hinge 41, in the hinged section 39 generally in the center of the hinged section 39 between the sides 43, there is an indentation 53. A cutting wheel support 55 is filled into the indentation 53 and extends slightly into the open center 35 of the ring. The axle 51 on which the cutting wheel 49 rotates is mounted in the cutting wheel support 55.

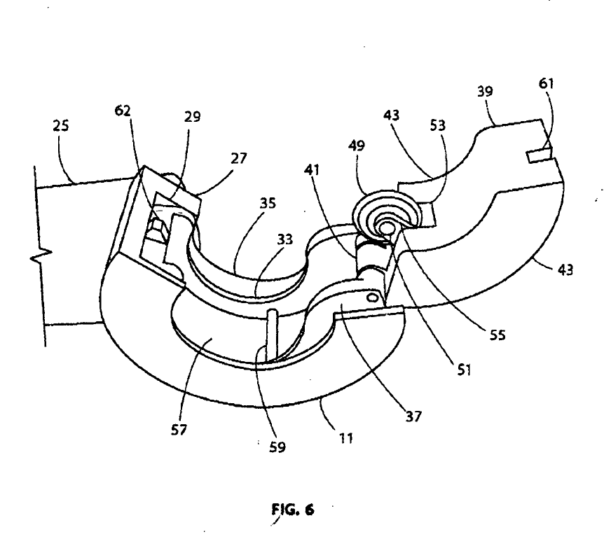

The hinged section 39 of the ring 33 is solid except for the indentation 53 that holds the cutting wheel support 55. The center of the cutting wheel support 55 provides space for the cutting wheel 49 to rotate. The main section 37 of the ring 33, which is the ring 33 absent the hinged section 39, is hollowed out in the center 57 area as can been seen in FIGS. 5 and 6. A stop bar 59 is located across the center area 57 at right angles to the sides 43 of the ring 33. The stop bar 59 is located between the retaining unit 61 and the hinge 41 but slightly closer to the hinge 41. At the end of the hinged section 39 remote from the hinge 41 there is a female retaining unit 61 which locks the hinged section 39 into the ring 33 when closed at the end of the main section 30 of the ring 33 there is a male retaining unit 62.

A spacer 63, which is removable, extends from the male retaining unit 62 located at the end of the hinged section 39 of the ring 33 remote from the hinge 41 to the stop bar 59. The spacer 63 has a U-shaped cross section 64 and the spacer 63 has an outside surface 65, which rests snugly in the center area 57 of the main section 37 of the ring 33 and conforms to the center area 57 of the ring 33. The spacer 63, shaped as part of a circle is sized consistent with the outside periphery of a tube or pipe 66 to be cut on both ends of the spacer 63, rollers 67 are mounted to rotate within the spacer 63. The spacer 63 will vary in size from spacer 63 to spacer 63 depending upon the outside diameter of the tube or pipe 66 to be cut. The spacer 63 is retained in place by means of a magnet 71 FIG. 5 embedded in the ring 33 but can be easily pried loose. The spacer 63 and the pair of rollers 67 are located opposite the cutting wheel 49.

To use the Tube Cutting Device, the hinged section 39 of the ring 33 is aligned with the open section 31 of the casing 27. The hinged section 39 is opened. A spacer 63 which is approximately sized is installed. The tube 66 to be cut is placed into the open center 35 with the cutting wheel 49 at the point on the tube or pipe 69 where the cut is to be made. The hinged section 39 is securely closed.

By energizing the motor 13, the shaft 23 and gear 47 are rotated. The ring 33, which is engaged by the gear 47, rotates within the casing 27. As the ring 33 rotates the cutting wheel 49 moves about the tube or pipe 69 while rolling on the tube or pipe 69 and turning on its own axle 51 thereby cutting the tube or pipe 69 quickly and effectively. The Tube Cutting Device, can be placed on a tube or pipe 66 close to other obstructions, and provides for a cutting tube or device 66 not accessible by even a small hand actuated-tube cutter.

While a preferred embodiment is shown and described herein, it should be understood that the present disclosure is made by way of example only and that variations in the described device and its uses are possible within the scope of this disclosure without departing from the subject matter coming within the scope of the following claims, and reasonable equivalency thereof, which claims are to be the invention.

1. A Tube Cutting Device comprising:
a casing having a circular shape with an open interior and an open section for access to the open interior;
a ring mounted within the casing to rotate within the casing and having a main section and a hinged section that opens
a cutting wheel mounted on the ring; and
means to rotate the ring within the casing.

2. The Tube Cutting Device according to the claim 1 wherein the hinged section of the ring is slightly smaller than the open section of the casing.

3. The Tube Cutting Device according to the claim 1 further including a pair of rollers mounted on the ring opposite from the cutting wheel.

4. The Tube Cutting Device according to the claim 1 wherein the means to rotate the ring include:
a motor having a shaft that rotates;
a handle, the motor being mounted on the handle;
means for supplying electric power to the motor including a switch.

5. The Tube Cutting Device according to claim 1 wherein the ring has gear teeth about its periphery.

6. A Tube Cutting Device comprising:
a motor having a shaft which rotates;
an enclosure about the motor and the shaft;
a handle extending from the enclosure;
means including a switch for supplying a electric power to the motor;
a casing having a U-shaped cross section mounted on the enclosure;
a ring mounted to rotate within the casing and having a main section and a hinged section that opens, the hinged section that opens, the hinged section being slightly smaller than the open section of the casing, the ring having gear teeth about it's periphery;
a gear mounted on the shaft of the motor engaging the gear teeth on the ring;
a cutting wheel;
means for mounting the cutting wheel on one hinged section of the ring;
a spacer including two rollers mounted on the main section of the ring, the spacer being generally opposite the cutting wheel; and
means for retaining the spacer in the ring.

7. The Tube Cutting Device according to claim 6 wherein:
the hinged section of the ring has an indentation; and further including:
a wheel support mounted in the indentation; and
an axle mounted on the wheel support.

8. The Tube Cutting Device according to claim 6 wherein the means for retaining the spacer in the ring includes a magnet embedded in the ring.

9. The Tube Cutting Device according to claim 6 further including a post extending across the main section of the ring generally at a right angle to the ring and located toward the hinged section.

10. A Tube Cutting Device comprising:
a motor having a shaft which rotates, the shaft having an end remote from the motor;
an enclosure about the motor and the shaft;
a handle extending from the enclosure;
means including a switch for supplying electric power to the motor;
a casing having a U-shaped cross section mounted on the enclosure;
a ring having an interior space mounted within the casing, the ring having side walls and having a main section and a hinged section. A hinge located between and connecting the hinged section and the main section, the hinged section rotating on the hinge to permit access to the interior space of the ring; the ring having gear teeth about its periphery, the hinged section being solid with an indentation adjacent the hinge, the main section being hollow;
a wheel support mounted in the indentation;
an axle mounted on the wheel support generally at right angles to the sidewalks of the ring;
a cutting wheel mounted on the axle, the cutting wheel being generally centrally located between the sides of the ring and being aligned with the ring;
male and female retaining units on the main section and the hinged section at the end of the hinged section opposite from the hinge;
a post extending across the ring in the main section of the ring generally at right angles to the side walls of the ring;
a magnet in the main section of the ring adjacent the retaining member;
a spacer with two rollers fitted into the main section of the ring between the retaining unit and the post and being secured by the magnet; and
a gear mounted on the shaft of the motor engaging the gear teeth on the ring.
